(19) United States
(12) Patent Application Publication
(10) Pub. No.: US 2010/0152031 A1
(43) Pub. Date: Jun. 17, 2010

(54) HIGH ACTIVITY ELECTROCATALYST

(75) Inventors: Nino Borchtchoukova, Batlam (IL); Gilles Chriqui, Jerusalem (IL); Shimshon Kogan, Beer Sheva (IL); Gennadi Finkelshtain, Lod (IL); Igor Barsukov, Glenview, IL (US)

Correspondence Address: GREENBLUM & BERNSTEIN, P.L.C., 1950 ROLAND CLARKE PLACE, RESTON, VA, 20191, US

(73) Assignee: MORE ENERGY LTD., Lod (IL)

(21) Appl. No.: 12/333,702

(22) Filed: Dec. 12, 2008

(51) Int. Cl. B01J 23/44; B01J 23/42

(52) U.S. Cl. 502/185; 502/339

(57) ABSTRACT

An electrocatalyst for an electrode comprises (i) an electrically conductive particulate support comprising one or more electrocatalytically active metals and (ii) an electrically conductive material which is substantially free of electrocatalytically active metals and has an electroconductivity which is higher than the electroconductivity of (i). This Abstract is not intended to define the invention disclosed in the specification, nor intended to limit the scope of the invention in any way.

### BACKGROUND OF THE INVENTION

1. Field of the Invention

The present invention relates to an electrocatalyst which is useful as an electrochemically active material of an electrode, for example, for catalyzing the oxidation of borohydride compounds at the anode of a liquid fuel cell, and to a method of improving the electrochemical activity of the electrocatalyst.

2. Background Information

Many conventional electrocatalysts for, e.g., various kinds of fuel cells contain noble metals such as, for example, platinum, ruthenium, rhodium, palladium, gold and silver, supported on an active carbon carrier of high surface area that provides high dispersion of the active metals. The metal content in these catalysts often is up to 60 wt. %, in most cases 20-40 wt. %. The presence of considerable amounts of such scarce and expensive materials in an electrocatalyst significantly affects (increases) the price thereof and in turn, that of fuel cells using such catalysts as, for example, anode material.

The need for considerable concentrations of noble metals in electrocatalysts is due to the demand for a high electrochemical activity of, for example, electrodes. One of the factors that lowers the anode activity is an unsatisfactory electroconductivity of the electrocatalyst. For instance, it has been found that a carbon support which provides the desired high dispersion of electrochemically active metals and optimal availability of liquid fuel to active sites causes a partial loss of power due to a low electroconductivity.

In view of the foregoing, it would be desirable to lower the amount of (noble) metal required for the production of the electrocatalyst without decreasing the electrochemical activity thereof, thereby improving the efficiency of the electrocatalyst. It has unexpectedly been found that this can be accomplished by “diluting” the electrocatalyst with a material that has a higher electroconductivity than that of the electrocatalyst.

### SUMMARY OF THE INVENTION

The present invention provides an electrocatalyst which is suitable for use as an electrochemically active material in an electrode. The electrocatalyst comprises (i) an electrically conductive particulate support which comprises one or more electrocatalytically active metals and (ii) an electrically conductive (preferably particulate) material which is substantially free of electrocatalytically active metals and has an electroconductivity which is higher than the electroconductivity of (i), thereby decreasing the electrical resistance of the catalyst.

In one aspect, the electroconductivity of component (ii) may be at least about 10% higher than the electroconductivity of component (i), e.g., at least about 15% higher, at least about 20% higher, or at least about 25% higher than the electroconductivity of component (i).

In yet another aspect of the electrocatalyst of the present invention, at least one of E/Eₜₕ and P/Pₜₕ may be at least 1.01, with
E=electrical energy provided by an anode which comprises the electrocatalyst of the present invention;
P=electrical power provided (after 1 h of operation) by an anode which comprises the electrocatalyst of the present invention;
Eₜₕ=theoretical electrical energy provided by an anode which comprises the electrocatalyst of the present invention, calculated based on the electrical energy that is provided by an anode which comprises the electrocatalyst without component (ii) at the same weight percentage as the weight percentage of the electrocatalyst of the present invention used for determining E and assuming a linear relationship between the concentration of the one or more metals in the anode and the electrical energy provided by the anode; and
Pₜₕ=theoretical electrical power provided (after 1 h of operation) by an anode comprising the electrocatalyst, calculated based on the electrical power that is provided by an anode which comprises the electrocatalyst without component (ii) at the same weight percentage as the weight percentage of the electrocatalyst of the present invention used for determining P and assuming a linear relationship between the concentration of the one or more metals in the anode and the electrical power provided by the anode.

In a still further aspect of the electrocatalyst of the present invention, at least one of E/E_{dir} and P/P_{dir} may be at least 1.01, with
E=electrical energy provided by an anode which comprises the electrocatalyst of the present invention;
P=electrical power provided (after 1 h of operation) by an anode which comprises the electrocatalyst of the present invention;
E_{dir}=electrical energy provided by an anode which differs from the anode used for determining E only in that it comprises an electrocatalyst wherein component (ii) was present already during the preparation of component (i); and
P_{dir}=electrical power provided (after 1 h of operation) by an anode which differs from the anode used for determining P only in that it comprises an electrocatalyst wherein component (ii) was present already during the preparation of component (i).

In another aspect of the electrocatalyst of the present invention, at least one of E/E_{und} and P/P_{und} may be at least 1.01, with
E=electrical energy provided by an anode which comprises the electrocatalyst of the present invention;
P=electrical power provided (after 1 h of operation) by an anode which comprises the electrocatalyst of the present invention;
E_{und}=electrical energy provided by an anode which differs from the anode used for determining E only in that it comprises an electrocatalyst which (a) comprises only component (i), (b) has the same metal concentration as the electrocatalyst of the present invention, and (c) is present in an amount which provides the same metal concentration in the anode as the metal concentration in the anode used for determining E; and
P_{und}=electrical power provided (after 1 h of operation) by an anode which differs from the anode used for determining P only in that it comprises an electrocatalyst which (a) comprises only component (i), (b) has the same metal concentration as the electrocatalyst of the present invention, and (c) is present in an amount which provides the same metal concentration in the anode as the metal concentration in the anode used for determining P.

In another aspect of the electrocatalyst of the present invention, the support of component (i) may comprise carbon and/or may have a specific surface area of from about 50 m²/g to about 2,500 m²/g and/or may have a particle size of from about 0.5 μm to about 100 μm.

In another aspect, the one or more electrocatalytically active metals of component (i) of the electrocatalyst of the present invention may comprise one or more noble metals and in particular, may comprise Pt and/or Pd. For example, the support of component (i) may comprise the one or more noble metals, for example, Pt and/or Pd, in a total concentration of from about 0.5% to about 40% by weight based on the total weight of support plus metal(s) and calculated as metals. If both Pt and Pd are present, the atomic ratio Pt:Pd may, for example, be from about 10:1 to about 1:10.

In another aspect of the electrocatalyst of the present invention, the electrically conductive material of component (ii) may comprise carbon and in particular, at least one of graphite, carbon black and activated carbon, preferably at least graphite. In another aspect, the electrically conductive material of component (ii) and in particular, carbon may have a specific surface area of from about 5 m ²/g to about 1000 m²/g, e.g., from about 10 m²/g to about 30 m²/g, and/or may have an average particle size of from about 0. 5 μm to about 100 μm, e.g., from about 10 μm to about 50 μm.

In yet another aspect of the electrocatalyst, the weight ratio of (i):(ii) may be from about 99:1 to about 10:90, for example, at least about 70:30 and/or not higher than about 95:5.

The present invention also provides an electrocatalyst which is suitable as electrochemically active material for use in an electrode, which electrocatalyst comprises (i) a particulate carbon support comprising at least one electrocatalytically active noble metal and (ii) an electrically conductive particulate material which is substantially free of noble metals and comprises graphite.

In one aspect of this electrocatalyst, the carbon of component (i) may have a specific surface area of from about 50 m²/g to about 2,500 m²/g and/or may have a particle size of from about 10 μm to about 75 μm.

In another aspect, the at least one electrocatalytically active noble metal of component (ii) may comprise Pt and/or Pd. For example, the support of component (i) may comprise Pt and Pd in a total concentration of from about 2% to about 10% by weight, calculated as metals and based on the total weight of support plus metals, and/or the atomic ratio Pt:Pd may be from about 5:1 to about 1:5.

In yet another aspect of the electrocatalyst of the present invention, the graphite of component (ii) may have a specific surface area of from about 10 m²/g to about 30 m²/g and/or may have a particle size of from about 10 μm to about 50 μm.

In a still further aspect, the weight ratio of (i):(ii) may be from about 95:5 to about 60:40. For example, the weight ratio may be at least about 75:25 and/or it may be not higher than about 90:10.

The present invention also provides an electrode which comprises an electrocatalyst of the present invention as set forth above (including the various aspects thereof). For example, the electrode may be an anode, or the electrode may be a cathode.

In one aspect, the electrode may further comprise a binder such as, e.g., polytetrafluoroethylene.

The present invention also provides a fuel cell, for example, a direct liquid fuel cell and/or a portable fuel cell, which comprises an electrode of the present invention as set forth above.

In one aspect, the fuel cell may comprise a fuel which comprises a borohydride compound.

The present invention also provides a method of increasing one or more of the electrochemical activity, the conductivity, and the efficiency (especially in an electrode, as reflected, e.g., by one or more of E/Eₜₕ, E/E_{dir}, E/E_{und}, P/Pₜₕ, P/P_{dir}, and P/P_{und} being at least 1.01) of an electrocatalyst without increasing the amount of electrocatalytically active metal used for the production thereof. The method comprises combining the electrocatalyst with an electrically conductive particulate material which is substantially free of electrocatalytically active metal and has an electroconductivity which is higher than the electroconductivity of the electrocatalyst.

In one aspect of this method, the electrically conductive particulate material may comprise graphite. In another aspect, the electrocatalytically active metal may comprise one or more noble metals (e.g., one or both of Pt and Pd).

The present invention also provides a method of increasing one or more of the electrochemical activity, the conductivity, and the efficiency (especially in an electrode, as reflected, e.g., by one or more of E/Eₜₕ, E/E_{dir}, E/E_{und}, P/Pₜₕ, P/P_{dir}, and P/P_{und} being at least 1.01) of an electrocatalyst. The method comprises blending (a) an electrocatalyst which comprises an electrically conductive particulate support comprising one or more electrocatalytically active metals with (b) an electrically conductive particulate material which has an electroconductivity which is higher than the electroconductivity of (a).

In one aspect of this method, components (a) and (b) may be blended in a mixer device at from about 500 to about 10,000 rpm and/or for from about 1 minute to about 10 minutes.

In another aspect, components (a) and (b) may be blended at a temperature of not higher than about 60° C., e.g., not higher than about 35° C.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show aspects of the present invention in more detail than is necessary for the fundamental understanding of the present invention.

As set forth above, the present invention provides, inter alia, an electrocatalyst which is suitable for use as an electrochemically active material of an electrode. The support of component (i) of the electrocatalyst will preferably comprise (activated) carbon as an electrically conductive carrier although any other materials which are suitable for this purpose may be used as well, either alone or in combination with (activated) carbon.

Especially (but not exclusively) in the case where the electrocatalyst is to be used as an oxidation catalyst for use in, e.g., an anode (for example, an anode of a fuel cell), examples of suitable electrocatalytically active (noble) metals of component (i) include Pt, Pd, Rh, Ru, Re, Ir and Au. These metals may be present either alone or in combination, for example as binary or ternary combinations such as, e.g., Pt/Pd, Pt/Ru, Pt/Rh, Pt/Re, Pt/Ir, Pt/Au, Pd/Ir, and Pd/Ir/Rh. In addition to or instead of the above metals the electrocatalyst of the present invention may comprise other metals as well. For example, component (i) may comprise one or more of Ag, Os, Ni, Co and Fe. Especially an electrocatalyst for use in a cathode will often not comprise noble metals as electrocatalytically active materials. The metals of component (i) are preferably present in elemental form (i.e., as metals and/or alloys thereof), although they may also be present in the form of suitable compounds thereof, or both.

If two or more metals are present in component (i) the weight ratio of any two metals, although not particularly limited, is preferably not higher than about 100:1, particularly not higher than about 50:1, e.g., not higher than about 20:1, not higher than about 15:1, not higher than about 10:1, not higher than about 8:1, or not higher than about 5:1.

The particulate support of component (i), for example, (activated) carbon of the electrocatalyst of the present invention will often have a specific surface area (as determined by; the BET method using nitrogen gas) of at least about 50 m²/g, e.g., at least about 100 m²/g, at least about 150 m²/g, at least about 200 m²/g, or at least about 250 m²/g. There is no particular upper limit for the specific surface area, but with increasing specific surface area of the support handling of the support will become more difficult (e.g., due to its increasingly pyrophoric properties). Accordingly, the specific surface area of the support will usually not be higher than about 2,500 m²/g, e.g., not higher than about 2,200 m²/g.

The support of component (i) will often have an average particle size (as determined by, e.g., sieving) of, e.g., not higher than about 100 μm, e.g., not higher than about 80 μm, not higher than about 70 μm, or not higher than about 50 μm, but usually not lower than about 1 μm, e.g., not lower than about 5 μm, or not lower than about 10 μm.

The support of component (i) may further comprise pores, including mesopores (i.e., pores having a diameter in the range of from about 2 nm to about 50 nm). If mesopores are present, the mesopore volume will usually be not higher than about 1.2 cm³/g, e.g., not higher than about 1.0 cm³/g, or not higher than about 0.8 cm³/g. The total pore volume will often be at least about 0.5 cm³/g, e.g., at least about 1 cm³/g, at least about 1.5 cm³/g, and will often not exceed about 2.5 cm³/g. The total pore volume, the diameter of the pores, and the fraction of the total pore volume that is attributable to mesopores may be determined, for example, by means of the standard BET procedure, e.g. with an adsorption apparatus Tristar 3000 (Micromeritics, Norcross, Ga.) or a similar apparatus.

Supports which are suitable for use in component (i) of the electrocatalyst of the present invention are available from many commercial sources. Non-limiting examples of suitable commercially available carbon supports are sold under the tradenames Vulcan XC-72, Vulcan P90, Black Pearls 2000, Black Pearls 450, Black Pearls 570, Regal 400, Regal 330 (all available from Cabot, USA), Picactif SC 10 (available from Pica USA Inc, Columbus, Ohio), Norit GSX, and Norit DLC (both available from Norit, Netherlands), to name but a few.

Non-limiting examples of materials for use in/as component (i) of the electrocatalyst of the present invention include carbon supported catalysts which are suitable for use in an anode and comprise Pt and/or Pd. The preparation of corresponding materials is described in, e.g., U.S. Pat. Nos. 3,804,779 and 6,797,667, U.S. Published Patent Application No. 2004/0219420 A1, U.S. patent application Ser. No. 11/434,795, and Y. Chen et al., J. Power Sources (2006), vol. 161, pp. 470-473. The entire disclosures of these documents are incorporated by reference herein.

The proportions of support (e.g., carbon) and the one or more electrocatalytically active metals of component (i) of the electrocatalyst of the present invention may vary over a wide range, although it is preferred that the amount of support is equal to at least the amount that is necessary for supporting all of the metals that are present. The one or more electrocatalytically active metals will usually be present at a concentration of at least about 0.5% by weight, e.g., at least about 1% by weight, at least about 2% by weight, at least about 3% by weight, at least about 4% by weight, at least about 5% by weight, or at least about 7% by weight, but usually not higher than about 40% by weight, e.g., not higher than about 30% by weight, not higher than about 20% by weight, not higher than about 15% by weight, or not higher than about 10% by weight, calculated as metals and based on the total weight of support plus metal(s).

The electrically conductive particulate material of component (ii) of the electrocatalyst of the present invention preferably comprises (or substantially consists of) carbon such as, e.g., one or more of graphite, carbon black and activated carbon, preferably (at least) graphite. Particularly preferably, at least about 50%, e.g., at least about 75%, or at least about 90% by weight, based on the total weight of the electrically conductive particulate material of component (ii), consists of graphite (with the remainder preferably consisting of carbon black and/or activated carbon). This electrically conductive particulate material is preferably substantially free of any electrocatalytically active metals and in particular, substantially free of any noble metals. “Substantially free” means that the material comprises less than about 0.1% by weight, preferably less than about 0.01% by weight, e.g., less than about 0.001% by weight of electrocatalytically active (noble) metals, based on the total weight of the material.

The particulate material of component (ii) of the electrocatalyst of the present invention (e.g., graphite) may be porous and will often have a specific surface area (as determined by the BET method using nitrogen gas) of at least about 5 m²/g, e.g., at least about 8 m²/g, at least about 10 m²/g, or at least about 15 m²/g, but usually not higher than about 1000 m²/g, e.g., not higher than about 500 m²/g, not higher than about 100 m²/g, not higher than about 50 m²/g, or not higher than about 30 m²/g. The pore volume of the particulate material of component (ii) will often be at least about 0.01 cm³/g, e.g., at least about 0.02 cm³/g, but usually not higher than about 10 cm³/g, e.g., not higher than about 5 cm³/g, or not higher than about 1 cm³/g.

Further, the particulate material of component (ii) of the electrocatalyst of the present invention will often have an average particle size (as determined by, e.g., sieving) of, e.g., not higher than about 100 μm, e.g., not higher than about 50 μm, not higher than about 40 μm, or not higher than about 30 μm, but usually not lower than about 0.5 μm, e.g., not lower than about 1 μm, not lower than about 5 μm, not lower than about 7 μm, or not lower than about 10 μm.

Porous graphite powders are preferred for use in/as component (ii) of the electrocatalysts of the present invention. Non-limiting examples of suitable commercially available graphite materials include graphite types IGC9390, 205-110, ABG1025, and SLA1518 (all produced by Superior Graphite Co., Chicago, Ill.), HSAG300CAT (Timcal, Westlake, Ohio)), Sodiff, Ketjen Black, Denka Black, and graphite KS-6, to name but a few.

The weight ratio (i):(ii) in the electrocatalyst of the present invention will usually be not higher than about 99:1, e.g., not higher than about 98:2, not higher than about 95:5, not higher than about 90:10, or not higher than about 80:20, and will often be not lower than about 10:90, e.g., not lower than about 25:75, not lower than about 50:50, not lower than about 70:30, or not lower than about 75:25.

The components of the electrocatalyst of the present invention can be combined in any suitable manner, preferably a manner which permits the preparation of an intimate mixture of components (i) and (ii). An example of a suitable mixing device is a blender. Mixing may be carried out, for example, at about 500 to about 10,000 rpm for about 1 minute to about 10 minutes, usually at ambient temperature (e.g., from about 10° C. to about 25° C.). Preferably, the mixing temperature is not higher than about 60° C. and particularly, not higher than about 35° C.

An electrode for, e.g., a fuel cell can be made from the electrocatalyst of the present invention in a conventional manner well known to those of skill in the art. For example, a material comprising the electrocatalyst of the present invention may be converted into a paste. The paste may be applied onto a suitable two-dimensional substrate (e.g., a sheet of paper or metal), and the substrate with the electrocatalyst thereon may be brought into the desired shape and dimensions of the electrode, optionally before or after reinforcement with, e.g., a metal grid or the like.

For forming the paste, the catalyst may be mixed with a liquid, e.g., water or a mixture thereof with a lower alcohol (such as, e.g., methanol, ethanol, propanol, isopropanol and butanol) and a suitable binder (such as, e.g., polytetrafluoroethylene).

The substrate may, for example, be carbon paper. The substrate with the catalyst paste thereon may be reinforced with a reinforcing element, e.g., a metal grid such as a nickel grid. A reinforcing element may be applied on one side or on both sides of the substrate. Also, two or more of the reinforced substrates may be combined, thereby forming sandwich or multilayer structures.

In addition to a wet process as set forth above, the electrode can also be made by a dry process. By way of non-limiting example, the electrocatalyst of the present invention may be mixed, e.g., kneaded, with polymer particles, e.g., polytetrafluoroethylene particles. The resultant mixture may then be converted into a sheet structure, e.g., by rolling. This sheet structure may then be brought into the desired shape and dimensions of the anode and further processed as set forth above with respect to the wet process.

The material comprising the electrocatalyst of the present invention may be employed, for example, as an anode and/or a cathode of a liquid fuel cell, preferably (at least) as an anode. The anode or the cathode of the fuel cell which is not made with the electrocatalyst of the present invention may be any anode or cathode that can be used with a liquid fuel cell. Examples thereof are well known to those of skill in the art. Preferably, a cathode according to the present invention is an air-breathing cathode. Non-limiting examples thereof include a cathode comprising one or more of Pt, Co and Ni on an electrically conductive carrier such as carbon.

In a preferred embodiment of an electrode (e.g., an anode) of the present invention the electrical resistance thereof (in Ohm.cm) is not more than about 75%, e.g., not more than about 50%, not more than about 40%, not more than about 30%, not more than about 25%, or not more than about 20% of the resistance of an electrode which differs from the electrode of the present invention only in that it has been made from the same weight percentage of electrocatalyst which comprises only component (i), i.e., without component (ii).

The structure of a typical fuel cell according to the present invention comprises an anode which in its operative state is in contact with a liquid fuel on one side and is in contact with a liquid, solid or gel electrolyte on its other side, and a cathode which also is in contact with the liquid electrolyte on one side thereof. The other side of the cathode is in contact with an oxidant, preferably oxygen, air or any other oxygen containing gas or liquid, such as hydrogen peroxide.

A liquid fuel for use in a fuel cell of the present invention may be any fuel that is suitable for liquid fuel cells. By way of non-limiting example, the liquid fuel may comprise water and/or a (monohydric or polyhydric) lower alcohol (usually a saturated aliphatic alcohol), in combination with a substance such as, e.g., NaBH₄, KBH₄, LiBH₄, Al(BH₄)₃, Zn(BH₄)₂, NH₄BH₄, (CH₃)₂NHBH₃, NaCNBH₃, a polyborohydride, LiAlH₄, NaAlH₄, CaH₂, LiH, NaH, KH, Na₂S₂O₃, Na₂HPO₃, Na₂HPO₂, K₂S₂O₃, K₂HPO₃, K₂HPO₂, HCOOH, NaCOOH and KCOOH or any combination of two or more thereof. The lower alcohol may, for example, be an alcohol having 1 to 6, e.g., 1 to 4 carbon atoms, and 1 or more, e.g., 1 to 4, OH groups. Non-limiting examples thereof are methanol, ethanol, n-propanol, isopropanol, n-butanol, isobutanol, pentanol, hexanol, ethylene glycol, propylene glycol, glycerol, pentaerythritol and any combination of two or more thereof. The liquid fuel may also comprise a basic compound, e.g., for the purpose of stabilizing the fuel. The basic compound may be any suitable organic or inorganic base, for example, an inorganic hydroxide, non-limiting examples whereof are ammonium hydroxide (NH₄OH) and (preferably alkali and alkaline earth) metal hydroxides, such as, e.g., NaOH, KOH and LiOH.

A liquid electrolyte that is suitable for use in a liquid fuel cell may comprise a base, for example an aqueous inorganic hydroxide. Non-limiting examples of the inorganic hydroxide are alkali metal hydroxides, such as, e.g., NaOH, KOH and LiOH. Non-limiting examples of liquid fuels and liquid electrolytes suitable for use in the fuel cell of the present invention are disclosed, for example, in U.S. Patent Application Publication Nos. 2002/0083640, 2002/0094459, 2002/0142196, 2003/0099876, 2005/0058882, 2006/0057437 and 2006/0147780 and in U.S. Pat. Nos. 5,599,640, 5,804,329, 6,544,877 and 6,773,470, the entire disclosures whereof are incorporated by reference herein.

The surface area of the anode (and of the cathode) of a fuel cell of the present invention is not particularly limited. Usually, however, the surface area is at least about 0.5 cm², e.g., at least about 2 cm², at least about 5 cm², at least about 10 cm², at least about 20 cm², or at least about 30 cm². On the other hand, the surface area is usually not larger than about 500 cm², e.g., not larger than about 300 cm², not larger than about 200 cm², not larger than about 100 cm², not larger than about 75 cm², or not larger than about 50 cm².

When used for making an anode, the electrocatalyst of the present invention will usually result in an increase in the electrical power and/or electrical energy provided by the anode compared to, e.g., an anode having the same concentration of electrocatalytically active metal(s), but comprised in a catalyst without component (ii). In particular, usually one or more of E/Eₜₕ, E/E_{dir}, E/E_{und}, P/Pₜₕ, P/P_{dir}, and P/P_{und} will be at least 1.01 (e.g., at least about 1.05, at least about 1.1, at least about 1.15, at least about 1.2, at least about 1.25, at least about 1.3, or at least about 1.5). Methods for determining E and P are set forth in the Examples below.

By way of illustration, the calculation of E/Eₜₕ may be carried out as follows: Under the assumption that anode A₁ which has been prepared with an electrocatalyst which comprises only component (i) provides an electrical energy of 20 Wh and an anode A₂ according to the present invention which has been prepared with the same amount of “diluted” catalyst, e.g., a catalyst having a weight ratio component (i) : component (ii) of 4:1, provides an electrical energy of 17 Wh under the same conditions, Eₜₕ is calculated to be 16 Wh (the metal concentration in anode A₂ is only 80% of the metal concentration in anode A₁ and assuming a linear relationship between electrical energy and metal content the electrical energy provided by anode A₂ would be expected to be 80% of the electrical energy provided by anode A₁). Accordingly, E/Eₜₕ equals 17/16=1.0625.

The liquid fuel cell of the present invention can be used to supply electrical energy to a virtually unlimited number of electric and electronic devices. Non-limiting examples thereof are (cellular) phones, (portable) computers, PDAs, consumer electronics, (portable) medical devices and components and peripherals thereof. It may also be used as a generator for emergency situations such as a power outage, as disclosed in U.S. Published Patent Application No. 2007/0298306, the entire disclosure whereof is incorporated by reference herein, as well as in military products such as, e.g., for field power generation or UAV (Unmanned Autonomous Vehicle) applications.

### EXAMPLES

### Example 1 (Comparative)

Catalyst Preparation.

50 g of catalyst was prepared as follows. 2.6 L of deionized water (pH=6-7, purified with ion exchange device “Zelion”, Israel) was added to a mixture of 56 ml of a 0.2 M aqueous solution of H₂PtCl₆ (Aldrich) and 103 ml of a 0.2 M aqueous solution of PdCl₂ (Aldrich). Both metal compounds were 99.9+% pure. The resultant solution was added to an aqueous slurry of 45 g of carbon powder in 3.1 L of deionized water. The carbon powder was type Vulcan X-72 (Cabot Corp.), having a particle size of 10-30 μm (measured by “Mastersizer-2000”, Malvern Instruments Ltd., Malvern, UK, as in all of the present Examples), a specific surface area according to BET of 241 m²/g and a total pore volume of 0.42 cm³/g (measured by “Tristar 3000”, Particle & Surface Sciences Pty. Limited, Dunstable, UK). The resultant suspension was stirred for about 30 min, whereafter 870 ml of 85% formic acid was added. The suspension was stirred for about 1 hour at about 100° C. and thereafter cooled to room temperature and filtered. The resultant filter cake was washed to neutrality (pH=6-7) and thereafter dried in a vacuum oven at about 90° C. for about 8 hours. The metal content in % by weight of the dried catalyst was determined by an SEM EDS analyzer Quanta 200, Phillips, as in all of the present Examples. Specifically, a powder like catalyst was pressed into a pellet having a diameter of about 10 mm and a thickness of about 1 mm. The concentrations of the metals were measured at ten points of the pellet. Standard deviations did not exceed 0.2% by weight.

The average concentrations (% by weight) of the metals in the catalyst were Pt 5. 1, Pd 4.9.

Anode Material Preparation.

25 g of the above catalyst was mixed with polytetrafluorethylene (PTFE) at a weight ratio catalyst/PTFE of 80/20. Mixing was carried out at room temperature with a blender for about 5 min.

Anode Preparation and Characterization.

The resultant mixture of catalyst and PTFE was placed into a rolling device to make a ribbon. The produced catalyst ribbon was placed on a nickel grid (wire diameter 0.14 mm, aperture size 0.4×0.4 mm) and pressed thereon, yielding the anode material. The ribbon was cut into anode pieces of 17 cm².

The electrochemical activity on the basis of the discharge characteristics in power-time and energy-time modes was investigated. Discharge characteristics of the anode were obtained in a cell (volume 50 cm³, distance between electrodes=4 mm, air cathode) with potassium borohydride as a fuel. 6.6 N KOH was used as the electrolyte. The cell was connected to a computerized Data logger measuring system (NIPCI 6225MDAQ, National Instruments, Austin, Tex., US) providing on-line measurements and register of current power (W) and amount of energy (Wh) produced. The energy was calculated as the integrated energy produced since the test start until the termination of the test when the power dropped to 0.4 W (indicated as “cut-off” energy). Two tests were carried out with each cell at a constant resistance of 0.33 Ohm for power measurements and of 0.47 Ohm for measurements of the “cut-off” energy. Variation of resistance (conductivity) was provided by connecting calibrated resistors in circuit. The accuracy of the measurements was ±0.01 W for power and ±0.1 Wh for “cut-off” energy. The metal concentrations in the anode were calculated according to

[(Pt+Pd, %) in catalyst]×[1−(PTFE, %)/100−(additive, %)/100 in anode].

The obtained results are set forth in Tables 1 and 2 below.

The electrical resistance of the anode (Ohm) was measured by means of a resistance meter and expressed as the resistance of a cubic conductor of a size of 1×1×1 cm (Ohm.cm). The resistance of the anode was 6.30 Ohm.cm.

### Example 2

The procedure described in EXAMPLE 1 was repeated with the exception that graphite powder, IGC9390 produced by Superior Graphite Co. (specific surface area=10 m²/g, pore volume=0.027 cm³/g) was added in the mixing stage. The weight ratio catalyst/graphite/PTFE was 75/5/20. The anode was tested as described in EXAMPLE 1 and the obtained results are set forth in Tables 1 and 2 below. The resistance of the anode was 1.20 Ohm.cm.

### Example 3 (Comparative)

50 g of catalyst containing 5.0 wt. % of Pt and 5.2 wt. % of Pd based on activated carbon Picatif SC 10 from Pica Co. (particle size=20-60 μm, specific surface area=2,047 m²/g, pore volume=1.61cm³/g) was prepared in accordance with the method described in EXAMPLE 1. 25 g of the catalyst was used for the anode preparation, and the anode was tested as described in EXAMPLE 1. The test results are set forth in Tables 1 and 2 below. The resistance of the anode was 8.86 Ohm.cm.

### Example 4

25 g of the catalyst of EXAMPLE 3 was used for the anode preparation as described in EXAMPLE 1 except that it was mixed with graphite IGC9390 as described in EXAMPLE 2. The weight ratio catalyst/graphite/PTFE was 60/20/20. The anode was tested as described in EXAMPLE 1. The obtained results are set forth in Tables 1 and 2 below. The resistance of the anode was 1.52 Ohm.cm.

### Example 5 (Comparative)

50 g of catalyst containing 5.1 wt. % of Pt and 4.8 wt. % of Pd based on activated carbon (Norit DLC produced by Norit Co., Netherlands, specific surface area=1911 m²/g , pore volume=1.16 cm³/g) was prepared as described in EXAMPLE 1. 25 g of the catalyst was used for the anode preparation as described in EXAMPLE 1. The anode was tested as described in EXAMPLE 1. The obtained results are set forth in Tables 1 and 2 below. The resistance of the anode was 9.27 Ohm.cm.

### Example 6

25 g of the catalyst described in EXAMPLE 5 was mixed with graphite powder ABG1025 produced by Superior Co. (specific surface area=18 m²/g , pore volume=0.056 cm³/g) as described in EXAMPLE 2 with the difference that the weight ratio catalyst/graphite/PTFE was 50/30/20. The anode was prepared and tested as described in EXAMPLE 1. The obtained results are set forth in Tables 1 and 2 below. The resistance of the anode was 0.18 Ohm.cm.

### Example 7 (Comparative)

75 g of catalyst was prepared as described in EXAMPLE 1 with the exception that the concentration of Pt was 2.4 wt. % and that of Pd was 2.5 wt. %. 25 g of the catalyst was used for the anode preparation described in EXAMPLE 1. The weight ratio catalyst/PTFE was 80/20. The anode was prepared and tested as described in EXAMPLE 1. The obtained results are set forth in Tables 1 and 2 below. The resistance of the anode was 9.12 Ohm.cm.

### Example 8

25 g of the catalyst of EXAMPLE 7 was mixed with graphite ABG1025 as described in EXAMPLE 2. The weight ratio catalyst/graphite/PTFE was 70/10/20. The anode was prepared and tested as described in EXAMPLE 1 and the obtained results are set forth in Tables 1 and 2 below. The resistance of the anode was 0.27 Ohm.cm.

### Example 9

25 g of the catalyst of EXAMPLE 7 was used for anode preparation with the difference that graphite HSAG300CAT produced by Timcal Co. (specific surface area=327 m²/g, pore volume=0.47 cm³/g) was used as graphite additive. The weight ratio catalyst/graphite/PTFE was 70/10/20. The anode was prepared and tested as described in EXAMPLE 1 and the obtained results are set forth in Tables 1 and 2 below. The resistance of the anode was 1.65 Ohm.cm.

### Example 10

25 g of the catalyst of EXAMPLE 7 was mixed with carbon black Ketjen Black EX 300J (specific surface area 620 m²/g, specific pore volume 0.48 cm³/g) as described in EXAMPLE 2. The weight ratio catalyst/carbon black/PTFE was 70/10/20. The anode was prepared and tested as described in EXAMPLE 1 and the obtained results are set forth in Tables 1 and 2 below. The resistance of the anode was 1.95 Ohm.cm.

### Example 11

25 g of the catalyst of EXAMPLE 7 was mixed with activated carbon from Heraeus Co., Germany (specific surface area 856 m²/g, specific pore volume 0.71 cm³/g) as described in EXAMPLE 2. The weight ratio catalyst/carbon black/PTFE was 70/10/20. The anode was prepared and tested as described in EXAMPLE 1 and the obtained results are set forth in Tables 1 and 2 below. The resistance of the anode was 3.28 Ohm.cm.

TABLE 1

| | | | | Content | Pt + Pd | | | | | |
|---|---|---|---|---|---|---|---|---|---|---|
| | Pt + Pd | | | of | wt. % | | | | | Cut off |
| Ex. | wt. % in | | Additive | Additive | in | Power W | | | | Energy |
| No. | catalyst | Support | (comp. (ii)) | wt. % | Anode | 1 h | 2 h | 6 h | 12 h | Wh |
| 1* | 10.0 | Vulcan | none | 0 | 8 | 0.88 | 0.96 | 1.00 | 0.94 | 17.2 |
| | | X-72 | | | | | | | | |
| 2 | 10.0 | Vulcan | IGC9390 | 5 | 7.5 | 0.97 | 1.00 | 1.02 | 1.01 | 18.9 |
| | | X-72 | | | | | | | | |
| 3* | 10.2 | Picatif | none | 0 | 8.2 | 1.06 | 1.11 | 1.11 | 1.05 | 18.5 |
| | | SC 10 | | | | | | | | |
| 4 | 10.2 | Picatif | IGC9390 | 20 | 6.1 | 1.10 | 1.12 | 1.16 | 1.14 | 19.8 |
| | | SC 10 | | | | | | | | |
| 5* | 9.9 | Norit | none | 0 | 7.9 | 1.00 | 1.05 | 1.11 | 1.08 | 18.5 |
| | | DLC | | | | | | | | |
| 6 | 9.9 | Norit | ABG1025 | 30 | 4.9 | 1.05 | 1.07 | 1.12 | 1.09 | 19.5 |
| | | DLC | | | | | | | | |
| 7* | 4.9 | Norit | none | 0 | 3.9 | 0.85 | 0.91 | 1.00 | 1.02 | 17.6 |
| | | DLC | | | | | | | | |
| 8 | 4.9 | Norit | ABG1025 | 10 | 3.4 | 0.96 | 1.03 | 1.09 | 1.08 | 18.4 |
| | | DLC | | | | | | | | |
| 9 | 4.9 | Norit | HSAG300C | 10 | 3.4 | 0.94 | 0.96 | 1.08 | 1.07 | 18.5 |
| | | DLC | AT | | | | | | | |
| 10 | 4.9 | Norit | Ketjen | 10 | 3.4 | 0.90 | 0.94 | 1.03 | 1.03 | 18.0 |
| | | DLC | Black EC | | | | | | | |
| | | | 300J | | | | | | | |
| 11 | 4.9 | Norit | Activated | 10 | 3.4 | 0.88 | 0.92 | 1.02 | 1.03 | 17.8 |
| | | DLC | Carbon | | | | | | | |
| | | | Heraeus | | | | | | | |

*= comparative

TABLE 2

| | Resistance, | E, | Eₜₕ, | | | | |
|---|---|---|---|---|---|---|---|
| Ex. No. | Ohm · cm | Wh | Wh | E/Eₜₕ | P, W | Pₜₕ, W | P/Pₜₕ |
| 1* | 6.30 | 17.2 | — | — | 0.88 | — | — |
| 2 | 1.20 | 18.9 | 16.13 | 1.17 | 0.97 | 0.83 | 1.16 |
| 3* | 8.86 | 18.5 | — | — | 1.06 | — | — |
| 4 | 1.52 | 19.8 | 13.76 | 1.44 | 1.10 | 0.79 | 1.39 |
| 5* | 9.27 | 18.5 | — | — | 1.00 | — | — |
| 6 | 0.18 | 19.5 | 11.5 | 1.70 | 1.05 | 0.62 | 1.69 |
| 7* | 9.12 | 17.6 | — | — | 0.85 | — | — |
| 8 | 0.27 | 18.4 | 15.4 | 1.20 | 0.96 | 0.74 | 1.29 |
| 9 | 1.65 | 18.5 | 15.4 | 1.21 | 0.94 | 0.74 | 1.26 |
| 10 | 1.95 | 18.0 | 15.4 | 1.17 | 0.90 | 0.74 | 1.21 |
| 11 | 3.28 | 17.8 | 15.4 | 1.18 | 0.88 | 0.74 | 1.18 |

*= comparative

As can be seen from the results set forth in Tables 1 and 2, the employed additives provide, inter alia, the following effects:
they increase the power and energy produced by about 3-10% compared to anodes without additive;
they permit a reduction of the concentration of noble metals in the anode by about 12-37%, depending on concentration and properties of the additive.

These effects result in considerable savings in the production of the electrocatalysts and in turn, the anodes.

A comparison of the results set forth for Examples 8-11 further shows that the use of graphite (Examples 8 and 9) as additive affords somewhat better results than the use of carbon black (Example 10) and activated carbon (Example 11).

### Example 12

A powder mixture of 40% by weight of Timcal HSAG300 high surface area graphite comprising 10% by weight of Co, 40% by weight of pore former carbon powder, 10% by weight of PTFE powder and 10% by weight of graphite powder ABG-1025 (Superior Graphite Co.) is agglomerated at room temperature in a M-20 machine (IKA Works, Inc., Wilmington, N.C.) at 30 krpm for 3×40 seconds. The agglomerated mixture is passed through a calender using a gap of 345 μm between rollers of 65 mm in diameter to produce a web having a thickness of 442 μm. Thereafter the web and a 20×20 Ni mesh having a thickness of 200 μm (Haver & Boecker OHG, Germany) and being pre-coated with Timrex LB-1016 conductive coating are passed together through a calender having a gap of 213 μm between calendering rollers of 65 mm in diameter to result in a current collector-web composite having a thickness of 373 μm. A porous PTFE sheet (R167-7 produced by Saint Gobain, France) is then pressure laminated (˜3 kN; color densitometer reading Cyan—0.22±3) to the current collector-web composite to afford a gas diffusion electrode of the present invention having a thickness of 440 μm.

### Example 13

A cathode is prepared as described in EXAMPLE 10, except that instead of powder mixture with the composition described in EXAMPLE 10 is prepared with the difference that instead of 10% by weight of graphite powder ABG-1025 10% by weight graphite powder SLA-1518 (Superior Graphite Co.) is used.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An electrocatalyst for an electrode, wherein the electrocatalyst comprises (i) an electrically conductive particulate support comprising one or more electrocatalytically active metals and (ii) an electrically conductive material which is substantially free of electrocatalytically active metals and has an electroconductivity which is higher than an electroconductivity of (i).

2. The electrocatalyst of claim 1, wherein at least one of E/Eₜₕ and P/Pₜₕ is at least 1.01, with
E=electrical energy provided by an anode which comprises the electrocatalyst;
P=electrical power provided (after 1 h of operation) by an anode comprising the electrocatalyst;
Eₜₕ=theoretical electrical energy provided by an anode which comprises the electrocatalyst, calculated based on the electrical energy that is provided by an anode which comprises the electrocatalyst without component (ii) at the same weight percentage as the weight percentage of the electrocatalyst used for determining E and assuming a linear relationship between the concentration of the one or more metals in the anode and the electrical energy provided by the anode; and
Pₜₕ=theoretical electrical power provided (after 1 h of operation) by an anode comprising the electrocatalyst, calculated based on the electrical power provided (after 1 h of operation) by an anode which comprises the electrocatalyst without component (ii) at the same weight percentage as the weight percentage of the electrocatalyst used for determining P and assuming a linear relationship between the concentration of the one or more metals in the anode and the electrical power provided by the anode.

3. The electrocatalyst of claim 1, wherein at least one of E/E_{dir} and P/P_{dir} is at least 1.01, with
E=electrical energy provided by an anode which comprises the electrocatalyst;
P=electrical power provided (after 1 h of operation) by an anode which comprises the electrocatalyst;
E_{dir}=electrical energy provided by an anode which differs from the anode used for determining E only in that it comprises an electrocatalyst wherein component (ii) was present already during the preparation of component (i); and
P_{dir}=electrical power provided (after 1 h of operation) by an anode which differs from the anode used for determining P only in that it comprises an electrocatalyst wherein component (ii) was present already during the preparation of component (i).

4. The electrocatalyst of claim 1, wherein at least one of E/E_{und} and P/P_{und} is at least 1.01, with
E=electrical energy provided by an anode which comprises the electrocatalyst;
P=electrical power provided (after 1 h of operation) by an anode which comprises the electrocatalyst;
E_{und}=electrical energy provided by an anode which differs from the anode used for determining E only in that it comprises an electrocatalyst which (a) comprises only component (i), (b) has the same metal concentration as the electrocatalyst which comprises component (ii), and (c) is present in an amount which provides a metal concentration in the anode which is the same as the metal concentration in the anode used for determining E; and
P_{und}=electrical power provided (after 1 h of operation) by an anode which differs from the anode used for determining P only in that it comprises an electrocatalyst which (a) comprises only component (i), (b) has the same metal concentration as the electrocatalyst which comprises component (ii), and (c) is present in an amount which provides a metal concentration in the anode which is the same as the metal concentration in the anode used for determining P.

5. The electrocatalyst of claim 1, wherein the support of (i) comprises carbon.

6. The electrocatalyst of claim 1, wherein the support of (i) has at least one of a specific surface area of from about 50 m²/g to about 2,500 m²/g and a particle size of from about 0.5 μm to about 100 μm.

7. The electrocatalyst of claim 1, wherein the one or more electrocatalytically active metals of (i) comprise at least one of Pt and Pd.

8. The electrocatalyst of claim 7, wherein the support of (i) comprises the at least one of Pt and Pd, calculated as metals, in a total concentration of from about 0.5% to about 40% by weight, based on a total weight of support plus metal.

9. The electrocatalyst of claim 8, wherein an atomic ratio Pt:Pd is from about 10:1 to about 1:10.

10. The electrocatalyst of claim 1, wherein the electrically conductive material of (ii) comprises carbon.

11. The electrocatalyst of claim 10, wherein the electrically conductive material of (ii) comprises at least one of graphite, carbon black and activated carbon.

12. The electrocatalyst of claim 11, wherein the electrically conductive material of (ii) comprises at least graphite.

13. The electrocatalyst of claim 10, wherein the electrically conductive material has a specific surface area of from about 5 m²/g to about 1000 m²/g.

14. The electrocatalyst of claim 10, wherein the electrically conductive material has a particle size of from about 0.5 μm to about 100 μm.

15. The electrocatalyst of claim 1, wherein a weight ratio of (i):(ii) is from about 99:1 to about 10:90.

16. The electrocatalyst of claim 15, wherein the weight ratio is from about 70:30 to about 95:5.

17. An electrocatalyst for an electrode, wherein the electrocatalyst comprises (i) a particulate carbon support comprising at least one electrocatalytically active noble metal and (ii) an electrically conductive particulate material which is substantially free of noble metals and comprises graphite.

18. The electrocatalyst of claim 17, wherein at least one of E/Eₜₕ and P/Pₜₕ is at least 1. 1, with
E=electrical energy provided by an anode which comprises the electrocatalyst;
P=electrical power provided (after 1 h of operation) by an anode comprising the electrocatalyst;
Eₜₕ=theoretical electrical energy provided by an anode which comprises the electrocatalyst, calculated based on the electrical energy that is provided by an anode which comprises the electrocatalyst without component (ii) at the same weight percentage as the weight percentage of the electrocatalyst used for determining E and assuming a linear relationship between the concentration of the one or more metals in the anode and the electrical energy provided by the anode; and
Pₜₕ=theoretical electrical power provided (after 1 h of operation) by an anode comprising the electrocatalyst, calculated based on the electrical power provided (after 1 h of operation) by an anode which comprises the electrocatalyst without component (ii) at the same weight percentage as the weight percentage of the electrocatalyst used for determining P and assuming a linear relationship between the concentration of the one or more metals in the anode and the electrical power provided by the anode.

19. The electrocatalyst of claim 17, wherein the carbon of (i) has at least one of a specific surface area of from about 50 m²/g to about 2,500 m²/g and a particle size of from about 10 μm to about 75 μm.

20. The electrocatalyst of claim 17, wherein (i) comprises at least one of Pt and Pd.

21. The electrocatalyst of claim 20, wherein the support of (i) comprises Pt and Pd, calculated as metals, in a total concentration of from about 2% to about 10% by weight, based on a total weight of support plus metal.

22. The electrocatalyst of claim 20, wherein an atomic ratio Pt:Pd is from about 5:1 to about 1:5.

23. The electrocatalyst of claim 17, wherein the graphite of (ii) has a specific surface area of from about 10 m²/g to about 30 m²/g.

24. The electrocatalyst of claim 23, wherein the graphite has a particle size of from about 10 μm to about 50 μm.

25. The electrocatalyst of claim 17, wherein a weight ratio of (i):(ii) is from about 95:5 to about 60:40.

26. The electrocatalyst of claim 25, wherein the weight ratio is from about 75:25 to about 90:10.

27. An electrode which comprises the electrocatalyst of claim 1.

28. An anode which comprises the electrocatalyst of claim 17.

29. The electrode of claim 27, wherein the electrode further comprises a binder.

30. The electrode of claim 29, wherein the binder comprises polytetrafluoroethylene.

31. A fuel cell which comprises the electrode of claim 27.

32. The fuel cell of claim 31, wherein the fuel cell is at least one of a direct liquid fuel cell and a portable fuel cell.

33. The fuel cell of claim 31, wherein the fuel cell comprises a fuel which comprises a borohydride compound.

34. A method of increasing one or more of the electrochemical activity, the conductivity, and the efficiency of an electrocatalyst without increasing an amount of electrocatalytically active metal used for a production thereof, wherein the method comprises combining the electrocatalyst with an electrically conductive particulate material which is substantially free of electrocatalytically active metal and has an electroconductivity which is higher than an electroconductivity of the electrocatalyst.

35. The method of claim 34, wherein the electrically conductive particulate material comprises carbon.

36. The method of claim 35, wherein the electrocatalytically active metal comprises one or more noble metals.

37. A method of increasing one or more of the electrochemical activity, the conductivity, and the efficiency of an electrocatalyst, wherein the method comprises blending (a) an electrocatalyst which comprises an electrically conductive particulate support comprising one or more electrocatalytically active metals with (b) an electrically conductive particulate material which has an electroconductivity which is higher than an electroconductivity of (a).

38. The method of claim 37, wherein (a) and (b) are blended in a mixer device at from about 500 to about 10,000 rpm for from about 1 minute to about 10 minutes.

39. The method of claim 37, wherein (a) and (b) are blended at a temperature of not higher than about 60° C.

40. The method of claim 39, wherein the temperature is not higher than about 35° C.
